(19) United States
(12) Patent Application Publication
(10) Pub. No.: US 2009/0302562 A1
(43) Pub. Date: Dec. 10, 2009

(54) MOWER WITH CUSHIONED SUSPENSION FOR OPERATOR SUPPORT PLATFORM HAVING STOWED AND DEPLOYED POSITIONS

(76) Inventors: Jeffrey B. Kallevig, Eden Prairie, MN (US); Jesse R. Gamble, Burnsville, MN (US); David J. Scherbring, Savage, MN (US)

Correspondence Address: JAMES W. MILLER, ATTORNEY, 527 MARQUETTE AVENUE, SUITE 1960, RAND TOWER, MINNEAPOLIS, MN, 55402, US

(21) Appl. No.: 12/467,029

(22) Filed: May 15, 2009

Related U.S. Application Data
(63) Continuation-in-part of application No. 12/002,798, filed on Dec. 18, 2007.
(60) Provisional application No. 60/875,749, filed on Dec. 19, 2006.

(51) Int. Cl. A01D 75/00

(52) U.S. Cl. 280/32.5; 280/32.7

(57) ABSTRACT

A stand-on riding mower has a support platform at the rear thereof for supporting an operator who stands during operation of the mower. The support platform is pivotally connected to the traction frame of the mower by a suspension that includes pivotal support plates at each side of the platform. At least one spring is arranged to push against the pivotal support plates in a direction causing the platform to rise such that the weight of the operator atop the platform causes the platform to lower until increasing biasing force in the spring balances the operator's weight. The spring ensures that impact shocks and the like on the traction frame of the mower are cushioned before reaching the operator's platform. In addition, the operator's platform is pivotal relative to the support plates to allow the operator's platform to be disposed in both a vertical stowed position and a horizontal deployed position.

### CROSS REFERENCE TO RELATED APPLICATIONS

This application is a continuation-in-part of application Ser. No. 12/002,798, filed Dec. 18, 2007, which claims the benefit of previously filed provisional Application Ser. No. 60/875,749, filed Dec. 19, 2006.

### TECHNICAL FIELD

This invention relates to a mower that is operated by an operator who is supported in a standing position by a support platform.

### BACKGROUND OF THE INVENTION

Various lawn mowers are known having a traction frame propelled by a pair of drive wheels. The drive wheels are independently driven by separate drive motors capable of both forward and reverse operation. A very sharp turn can be executed by operating one drive wheel in a forward direction while simultaneously operating the other drive wheel in a reverse direction. Such mowers are often referred to as skid steer mowers or zero radius turn mowers or the like.

In some mowers of this type, the operator is carried at the rear of the mower atop a support platform on which the operator stands. In a further subset of these mowers, the support platform is fixed to the traction frame in an essentially rigid fashion. Thus, the support platform is subjected to the same bumps and shocks experienced by the traction frame as the mower is driven over the ground. Since the traction frame of such a mower is not usually cushioned to provide a soft ride, the bumps or shocks encountered by the mower are transmitted through to the support platform largely unabated.

Consequently, the ride experienced by the operator who stands on the support platform can be quite rough particularly when the mower is operating over uneven terrain. This can be uncomfortable and annoying to the operator. Moreover, it can be difficult for the operator to keep his or her balance on the support platform which is a distraction for the operator. Thus, the use of a rigidly supported platform on the traction frame can potentially interfere with the safe operation of the mower and certainly makes the task of operating the mower more tiring for the operator.

Some mowers with an operator support platform attempt to improve the ride for the operator by using a plurality of springs between the support platform and the frame. The springs push up on the support platform and are depressed when the operator steps onto the support platform. However, in known mowers of this type, the amount of travel allowed for the support platform is very small, e.g. about ½″. Thus, there will be times when the support platform bottoms out and the operator is still subjected to shocks and bumps encountered by the mower.

### SUMMARY OF THE INVENTION

One aspect of this invention relates to a mower of the type having a traction frame which is self propelled by at least one drive wheel. A cutting deck for mowing grass is carried on the traction frame. An operator platform has at least a substantially horizontal deployed position in which an operator is able to stand atop the platform to operate the mower. A suspension is interposed between the operator platform and the traction frame. The suspension comprises a first elastomeric bumper carried on a forwardly facing surface of the operator platform with the first elastomeric bumper resting against a rearwardly facing surface on the traction frame when the operator platform is in the substantially horizontal deployed position. The operator platform is pivotal about a substantially horizontal pivot axis when the operator platform is in the substantially horizontal deployed position thereof such that the weight of an operator standing atop the operator platform compresses the first elastomeric bumper to provide a cushioned ride to the operator standing atop the operator platform. A second elastomeric bumper is also carried on the forwardly facing surface of the operator platform with the second elastomeric bumper being shorter than the first elastomeric bumper to be spaced away from the rearwardly facing surface of the traction frame by an initial gap when the first elastomeric bumper abuts against the rearwardly facing surface of the traction frame. The second elastomeric bumper is compressed by the operator standing atop the operator platform only after the first elastomeric bumper is first compressed enough by the operator's weight to close the initial gap between the second elastomeric bumper and the rearwardly facing surface on the traction frame.

Another aspect of this invention relates to a suspension for attaching an operator support platform to the rear of a self propelled traction frame for providing a cushioned ride to an operator standing atop the operator support platform as the traction frame travels over the ground. The suspension comprises a pivotal connection for pivotally attaching the operator support platform for pivoting motion relative to the traction frame about a substantially horizontal pivot axis. At least a pair of elastomeric bumpers is positioned between the operator support platform and the rear of the traction frame when the operator is standing atop the operator support platform such that the weight of the operator atop the platform will pivot the platform downwardly in a direction tending to compress the pair of elastomeric bumpers. A first bumper in the pair of bumpers is longer than a second bumper in the pair of bumpers such that the first bumper is at least partially compressed before compression of the second bumper begins.

### BRIEF DESCRIPTION OF THE DRAWINGS

This invention will be described hereafter in the Detailed Description, taken in conjunction with the following drawings, in which like reference numerals refer to like elements or parts throughout.

FIG. 1 is a perspective view of a portion of a mower according to this invention, particularly illustrating the cushioned suspension of this invention with the operator support platform in a substantially horizontal, deployed position;

FIG. 2 is a side elevational view of the portion of the mower shown in FIG. 1, with an additional portion of the mower removed to show the suspension in a centered state relative to a fixed stop in the form of a cylindrical cross member on the traction frame;

FIG. 3 is a top plan view of the portion of the mower shown in FIG. 1;

FIG. 4 is a perspective view similar to FIG. 1, but showing the operator support platform in a substantially vertical, stowed position;

FIG. 5 is a partial top plan view of a portion of the cushioned suspension of this invention;

FIG. 6 is a rear perspective view of the portion of the mower shown in FIG. 1, particularly illustrating the operator support platform;

FIG. 7 is a side elevational view of a second embodiment of a cushioned suspension according to this invention, particularly showing the operator support platform in a substantially horizontal, deployed position;

FIG. 8 is another perspective view of the cushioned suspension of FIG. 7, particularly illustrating the operator support platform in a substantially vertical, stowed position to better show a plurality of elastomeric cushioning members on a forwardly facing edge of the platform that form part of the cushioned suspension; and

FIG. 9 is a bottom plan view of a portion of the platform of FIG. 7, particularly showing the platform in the substantially horizontal, deployed position thereof with a first pair of the elastomeric cushioning members on the foot platform in engagement with a rearwardly facing portion of the traction frame.

### DETAILED DESCRIPTION

One embodiment of a mower according to this invention is illustrated generally as 2. Only the rear of mower 2 is illustrated since this is the portion of mower 2 that carries the improvement of this invention.

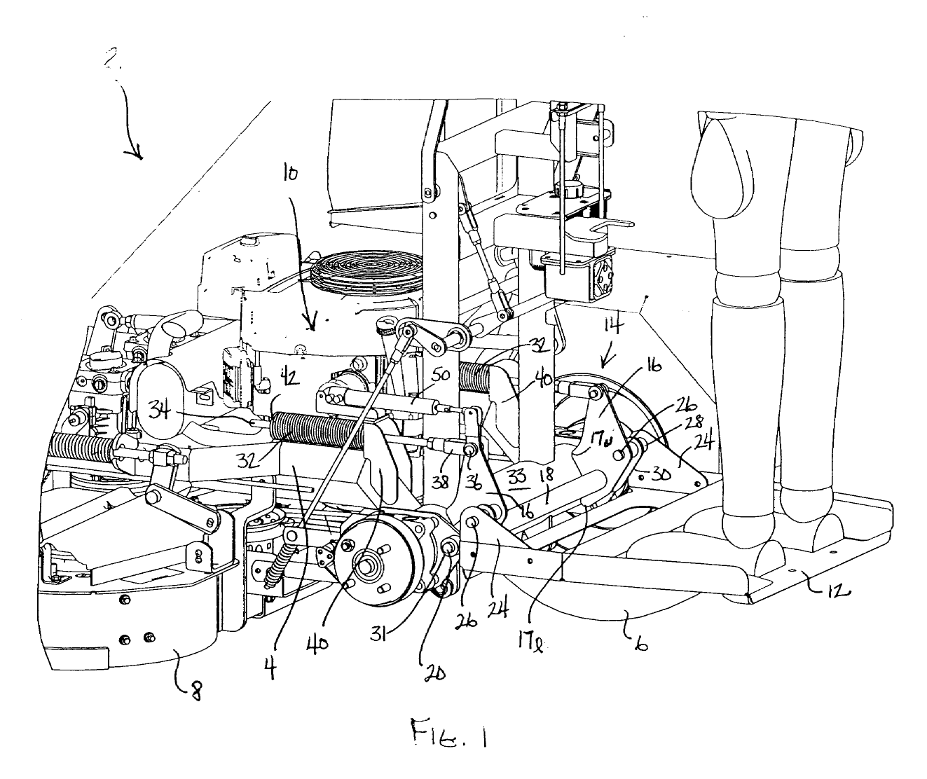

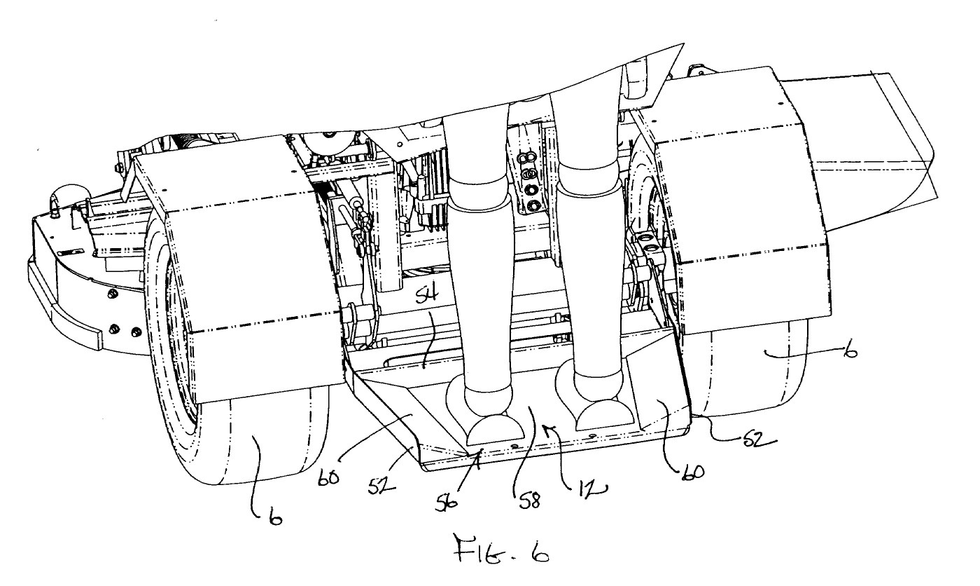

Mower 2 comprises a traction frame 4 that is propelled over the ground by a pair of rear drive wheels 6. See FIG. 6. Only drive wheel 6 on the far side of mower 2 is shown in FIGS. 1-4 with drive wheel 6 on the near side of mower 2 having been removed for the purpose of clarity. Drive wheels 6 are independently powered for forward and reverse operation by separate drive motors (not shown). Thus, mower 2 is capable of skid steer or zero radius turn operation.

The front of traction frame 4 carries a pair of unpowered caster wheels (not shown). A cutting deck 8 for mowing grass is suspended beneath a portion of traction frame 4 between the front caster wheels and rear drive wheels 6. Cutting deck 8 has one or more rotary cutting blades (not shown). Mowers 2 of this general type are well known in the mower art.

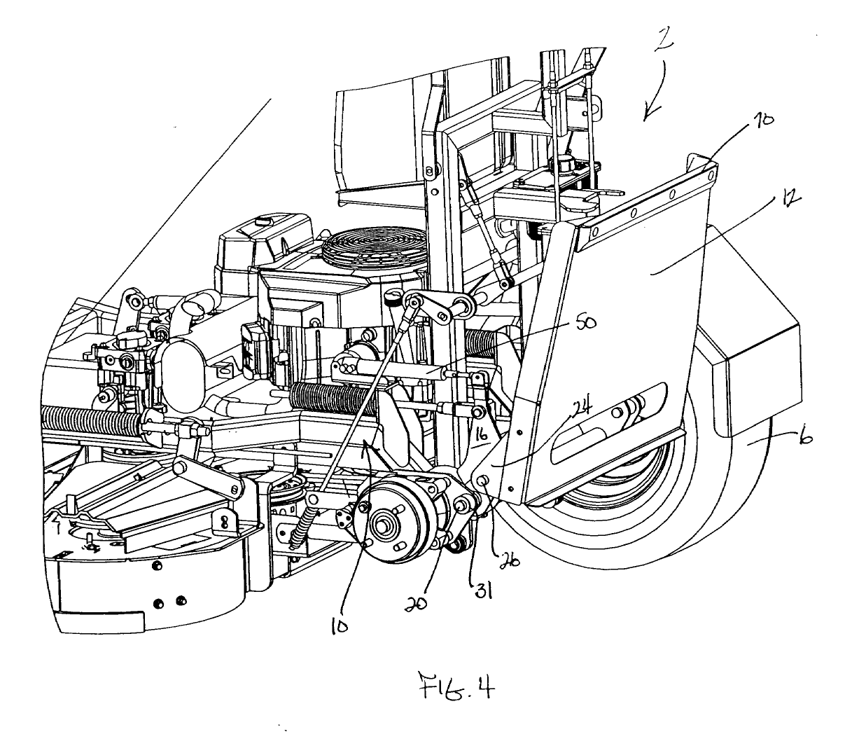

This invention relates to a cushioned suspension, indicated generally as 10, for an operator support platform 12. Suspension 10 and platform 12 are located at the rear of traction frame 4. Suspension 10 provides a cushioned and more comfortable ride for an operator who stands atop platform 12 when platform 12 is in a substantially horizontal, deployed position shown in FIGS. 1-3. In addition, platform 12 is itself pivotally mounted on suspension 10 to allow platform 12 to also be placed in a substantially vertical, stowed position shown in FIG. 4.

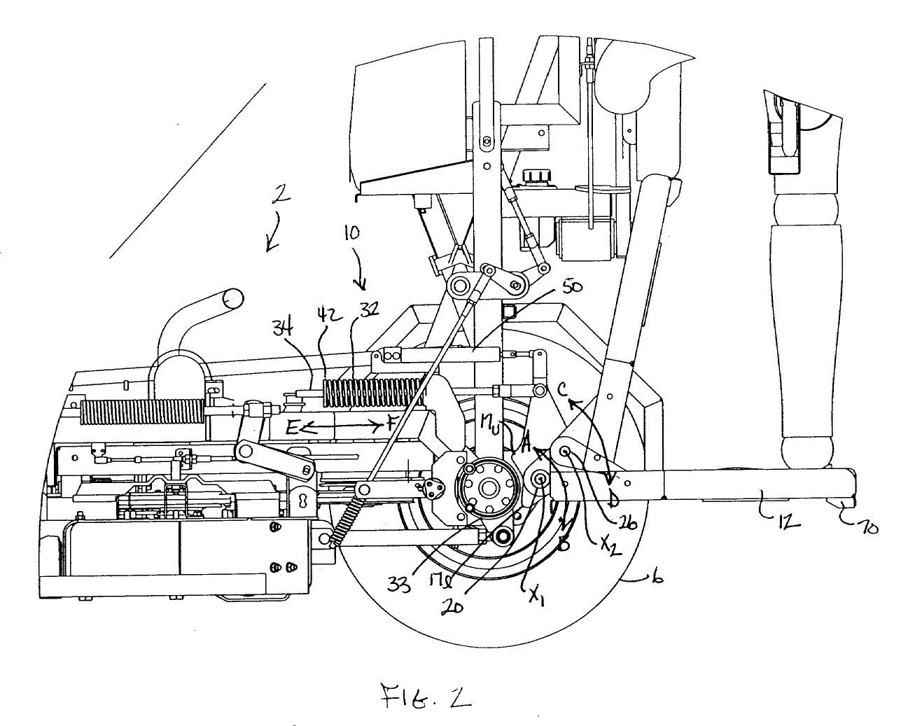

Suspension 10 comprises a U-shaped suspension cradle 14 formed by a pair of laterally spaced support plates 16 that are fixed to a cross tube 18. A transverse pivot axle or shaft 20 is fixed to the rear of traction frame 4. Pivot shaft 20 passes through cross tube 18 to rotatably journal cradle 14 on traction frame 4. Thus, cradle 14 is free to rock back and forth relative to traction frame 4 about a first substantially horizontal pivot axis x1 defined by the axis of pivot shaft 20, as shown by the arrows A and B in FIG. 2.

Platform 12 is itself suspended from cradle 14 by a pair of laterally spaced, upwardly extending mounting ears 24 fixed to the front of platform 12. Each mounting ear 24 is suspended from cradle 14 by a pair of pivot pins 26 that are aligned with one another along a common axis. Thus, platform 12 can pivot relative to cradle 14 about a second substantially horizontal pivot axis x2 defined by the aligned axes of pivot pins 26, as shown by the arrows C and D in FIG. 2.

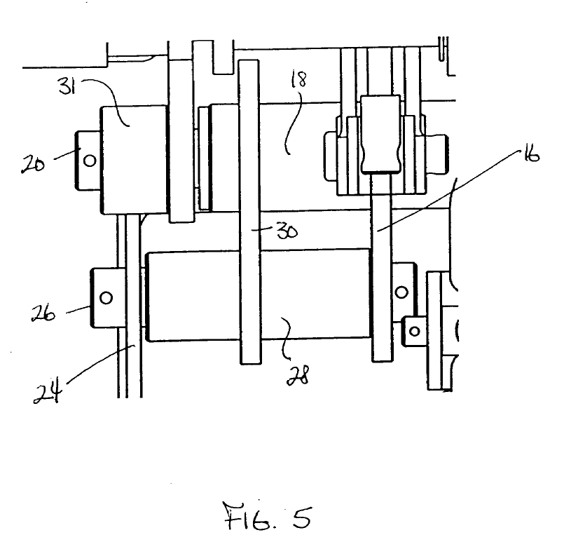

Referring to FIG. 5, each pivot pin 26 is long enough to span between and pass through a mounting ear 24 and the support plate 16 adjacent to that mounting ear 24. Thus, each mounting ear 24 and support plate 16 are pivotally received on opposite ends of each pivot pin 26. In addition, each pivot pin 26 is supported by a transverse hub or spacer 28 that spans the distance between mounting ear and support plate 16. Hub or spacer 28 is also additionally supported by an intermediate link arm 30 placed between mounting ear 24 and support plate 16. The lower end of link arm 30 is fixed to cross tube 18 and the upper end of link arm 30 is fixed to hub or spacer 28.

Referring to FIGS. 1-3, the deployed position of platform 12 is one in which platform 12 is disposed in a substantially horizontal position behind rear drive wheels 6. In the deployed position, the operator is able to stand atop platform 12 while operating mower 2 using controls (not shown) located at rear of traction frame 4. Referring to FIG. 4, the stowed position of platform 12 is one in which platform 12 is disposed in a substantially vertical position in which platform 12 is substantially upright adjacent the rear of mower 2. A catch or lock (not shown) is provided for latching platform 12 in the stowed position thereof.

Platform 12 pivots on suspension 10 about second substantially horizontal pivot axis x2 in moving back and forth between the deployed and stowed positions as shown by the arrows C and D in FIG. 2. This pivoting is done manually by the operator with the operator manually lifting platform 12 to move it up into the stowed position. After the platform catch or lock is released, platform 12 will pivot under the force of gravity to its deployed position and gravity will keep platform 12 in its deployed position. The operator could also manually retard or slow the downward motion of platform 12 by keeping a hand under platform 12 as gravity pivots platform 12 downwardly. In the deployed position of platform 12, the front side of each ear 24 rests against a rotatable cushion or bumper 31 contained on the outer ends of pivot axle or shaft 20.

Suspension 10 includes a pair of compression springs 32 acting between traction frame 4 and support plates 16 of cradle 14. Compression springs 32 are identically arranged between traction frame 4 and support plates 16. Thus, a description of one compression spring 32 in relation to its corresponding support plate 16 will suffice to describe the other compression spring 32 as well.

Support plate 16 includes a forwardly extending rod 34 pivotally connected to the top of support plate 16 rod by a pin 36 and a clevis 38. Rod 34 passes through a bracket 40 on the rear of traction frame 4 and extends some distance forwardly of bracket 40. Spring 32 is also placed ahead of bracket 40. Spring 32 concentrically surrounds rod 34 and is shorter than the length of that portion of rod 34 extending forwardly of bracket 40.

The rear end of spring 32 bears against bracket 40. The front end of spring 32 bears against a washer 42 that is adjustably held in place on rod 34 by a threaded nut (not shown). The nut can be moved back and forth along rod 34 to adjust the compression of spring 32. Spring 32 pushes forwardly on rod 34 in the direction of arrow E in FIG. 2 so as to rotate support plate in the direction of arrow A to thereby rotate platform 12 in the direction of arrow C.

When platform 12 is in its deployed position and the operator is not standing on platform 12, springs 32 act on platform 12 in a direction that causes platform 12 to lift or rise relative to traction frame 4. This lift or rise of platform 12 will continue until such time as an upper nose 17u on each support plate 16 engages against the top of a fixed cylindrical cross member 33 on traction frame 4. See FIG. 2. This will be the usual or unloaded state of platform 12 when platform 12 is in its deployed position but no operator is standing on platform 12. Platform 12 will be somewhat lifted relative to traction frame 4, plates 16 will be rotated about pivot axis x1 in the direction of arrow A, and the upper noses 17u on support plates 16 will be resting against the stop formed by fixed cross member 33.

When the operator stands on platform 12 and applies his or her weight thereto, platform 12 and support plates 16 will each rotate in the directions B and D shown in FIG. 2. Each rod 34 is pulled rearwardly in the direction of the arrow F in FIG. 2, thus compressing each spring 32 between washer 42 carried adjacent the front end of spring 32 and the corresponding bracket 40. This compression continues until the combined biasing force of springs 32 balances out the weight of the operator on platform 12. If springs 32 are properly adjusted, this will happen before a lower nose 17l on support plates 16 engages against fixed cross member 33, which serves to stop out motion of suspension 10 in the direction of arrow B in FIG. 2.

Springs 32 are desirably preloaded to adjust the amount of biasing force they provide by using the nut to move or adjust the position of washer 42 along rod 34. The amount of the preload is selected in relation to the weight of the operator such that support plates 16 are preferably centered relative to fixed cross member 33 when the operator is standing atop platform 12. The centered relationship of support plates 16 is one in which both upper nose 17u and lower nose 17l are roughly equidistant from fixed cross member 33 as shown in FIG. 2. Note in FIG. 2 that both upper nose 17u and lower nose 17l are spaced by a similarly sized gap from cross member 33. This provides substantially equal travel to suspension 10 in directions A and B as the mower is operated. Preferably, this travel is on the order of 2″ or so in each direction for a total travel of 4″.

As mower 2 is driven over the ground, platform 12 is free to rock up and down about pivot axis x1 as mower 2 encounters various undulations in the terrain, at least until either of the noses 17u or 17l hits cross member 33 at the end of the designed range of travel. But before the motion of suspension 10 is so stopped out, the ride experienced by the operator is cushioned by springs 32 contained in suspension 10. Impact shocks and the like are absorbed and at least partially attenuated by suspension 10 and are not fully transmitted through to platform 12. Thus, it is much more comfortable for the operator to stand atop platform 12 and to operate mower 2 than the rigidly affixed platforms of the prior art. The maximum range of travel of suspension 10, on the order of 4″ or so, is large enough so that the motion of suspension 10 will not be stopped out except perhaps only very occasionally.

An adjustable gas or hydraulic dampener 50 is also pivotally attached between traction frame 4 and at least one support plate 16. The purpose of dampener 50 is to slow the rate of motion of platform 12 about pivot axis x1. This further improves the ride for the operator by dampening and slowing any oscillatory movement of platform 12 about axis x1 that might occur as mower 4 is being driven. One dampener 50 will be sufficient. Moreover, the use of dampener 50 is optional

As noted above, the pivotal cushioned suspension 10 provides a more comfortable ride for an operator who is standing on platform 12. However, platform 12 is itself pivotally mounted on suspension 10 to allow platform 12 to be conveniently placed in either a deployed or stowed position relative to mower 2. This is done merely by pivoting platform 12 about pivot axis x2 carried on suspension 10. When platform 12 is in its stowed position, the front to back length of mower 2 is decreased to allow for more convenient transport on a trailer or more compact storage. This is also an advantage.

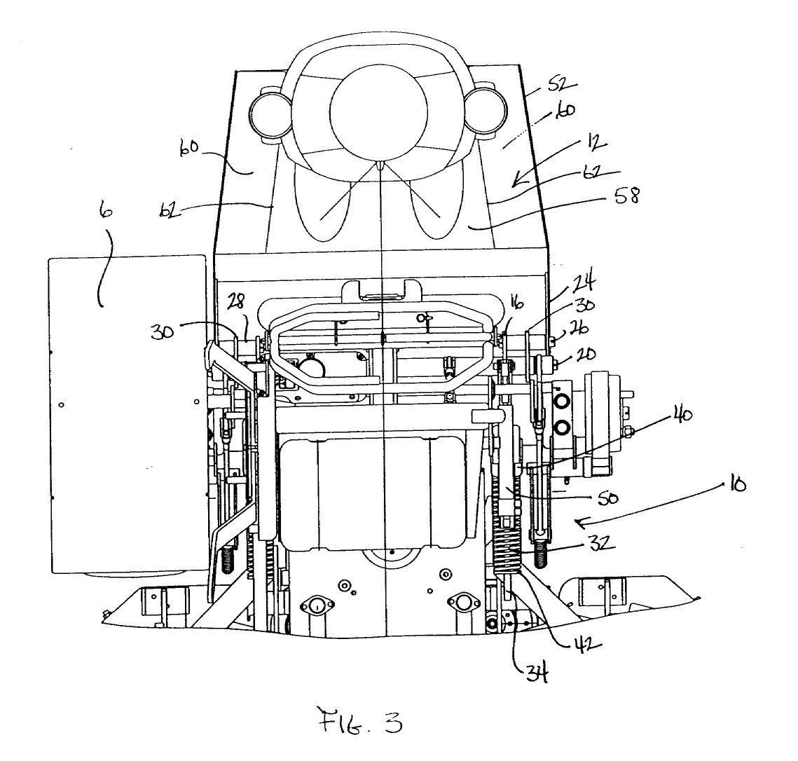

Referring now to FIGS. 3 and 6, platform 12 has spaced upwardly extending side walls 52 bounded by an upwardly extending front wall 54. The rear of platform 12 is open without any type of upwardly extending rear wall to permit the operator to more easily step up onto or step down off of platform 12. A floor 56 extends between side walls 52 behind front wall 54. The operator can stand atop platform 12 by standing on floor 56.

Floor 56 is not planar over its entire area. Floor 56 has a planar, flat central portion 58 that occupies most of the area of floor 56. In addition, floor 56 has a pair of tilted ramps 60 on each side of central portion 58. Ramps 60 fill in or occupy the remaining area of floor 56.

Each ramp 60 has a triangular cross-section such that each ramp 60 progressively gets higher as ramp 60 extends laterally outwardly. The inner side of ramp 60 feathers down into central portion 58 of floor 56 to be flush with central portion 58 of floor 56. The outer side of ramp 60 is about as high as side wall 52 of floor 56.

In addition, as shown in FIG. 3, the inner sides 62 of ramps 60 are not parallel to one another or parallel to a straight fore-and-aft direction. Instead, inner sides 62 of ramps 60 progressively spread apart as one proceeds from the rear of platform 12 towards the front of platform 12, i.e. towards front wall 54. Accordingly, the flat central portion 58 of floor 56 is not square or rectangular, but is a trapezoid whose lateral sides diverge outwardly as one proceeds from the back to the front.

The laterally diverging area of the flat central portion 58 of floor 56, formed by the laterally diverging inner sides 62 of ramps 60, echoes or mimics the natural orientation of the operator's feet when the operator is standing on platform 12. Most people stand with their feet spread apart but with their feet slightly pointed or tilted to the outside. In other words, when most people stand, the person's right foot normally points slightly to the right and the left foot normally points slightly to the left. The diverging shape of the flat central potion 58 is meant to mimic this shape to form a space in which the user will more naturally place his or her feet. Thus, the user will find it easier to stand on platform 12 in a centered position and in a natural fashion.

In addition, the inclination of ramps 60 is meant to provide a generally horizontal foot pad when the mower is being operated on a sidehill. When this occurs, the entire platform 12, indeed the entire mower 2, is tilted at an angle generally corresponding to the angle of the sidehill. However, in this situation, the top surface of ramp 60 on the downhill side of platform 12 will now be generally horizontal. Thus, when operating on a sidehill, the operator can shift his or her downhill foot from the flat central portion 59 and place such foot atop the downhill ramp 60. This allows the operator to stand with the downhill foot atop the downhill ramp 60 much more easily than if ramp 60 were not present. This makes platform 12 more comfortable to ride on a sidehill.

If desired, platform 12 can include a plastic wear strip 70 on the underside thereof. As shown in FIGS. 2 and 4, such a wear strip 70 is located along the underside of the rear edge of floor 56 of platform 12. This wear strip 70 will prevent wear or damage to platform 12 if platform 12 should strike an obstacle, such as when mower 2 is being driven up over a curb or the like.

Many different types of springs or other resilient biasing devices could be used. For example, tension or torsion springs could be substituted for compression springs 32 and elastomeric biasing devices could be used in place of springs. Where the springs are located and how they interact with suspension 10 can all be varied, though it is desired that the biasing force be applied in a direction that causes platform 12 to rise or lift relative to traction frame 4 when platform 12 is in its deployed position by is not loaded with the weight of the operator.

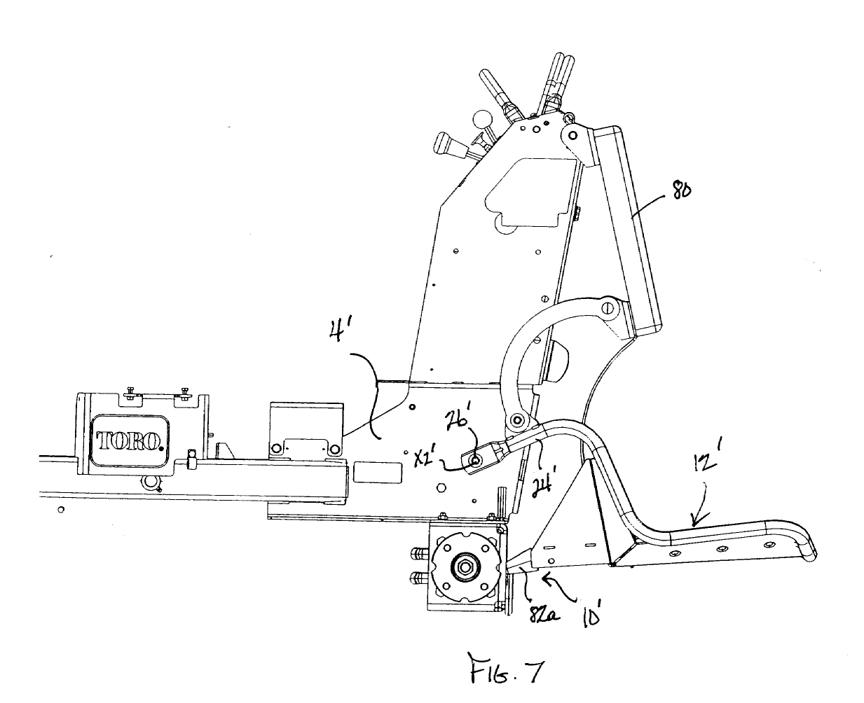

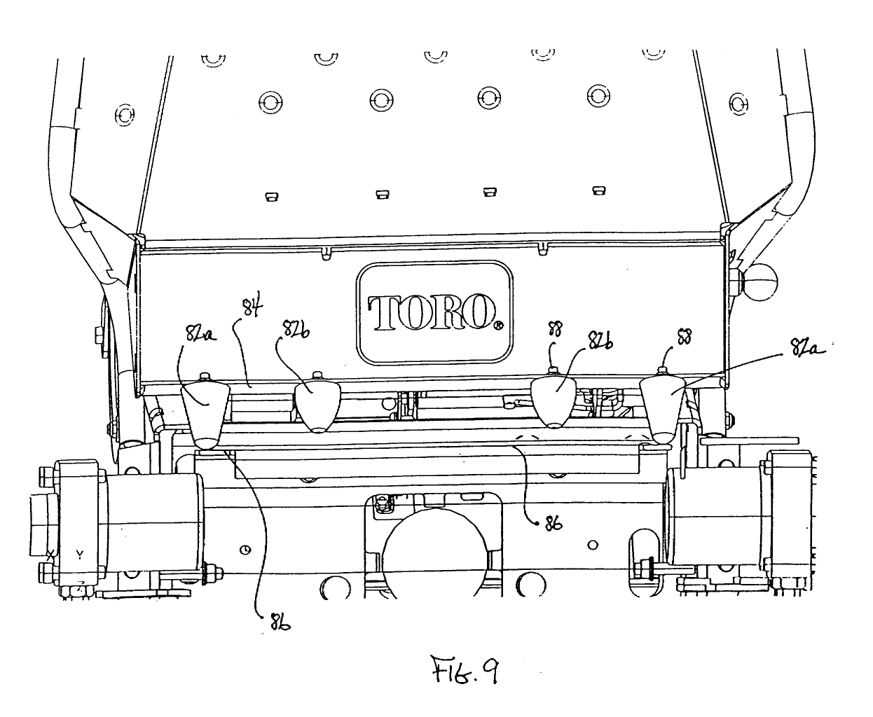

Referring now to FIGS. 7-9, a second embodiment of a cushioned suspension according to this invention is illustrated generally as 10′. Components in system 10′ that correspond to components found in system 10 will be referred to by the same reference numerals but with a prime designation following the numeral. Thus, system 10′ includes a pivotal foot platform 12′ having a pair of laterally spaced, upwardly extending mounting ears 24′ in the form of relatively long, L-shaped arms. Each mounting ear 24′ is suspended directly from the rear of traction frame 4′ by a pivot pin 26′ with pivot pins 26′ lying along a common transverse axis. Thus, platform 12′ can pivot relative to traction frame 4′ about a single substantially horizontal pivot axis x2′ defined by the aligned axes of pivot pins 26′, as shown by the arrows C′ and D′ in FIG. 7.

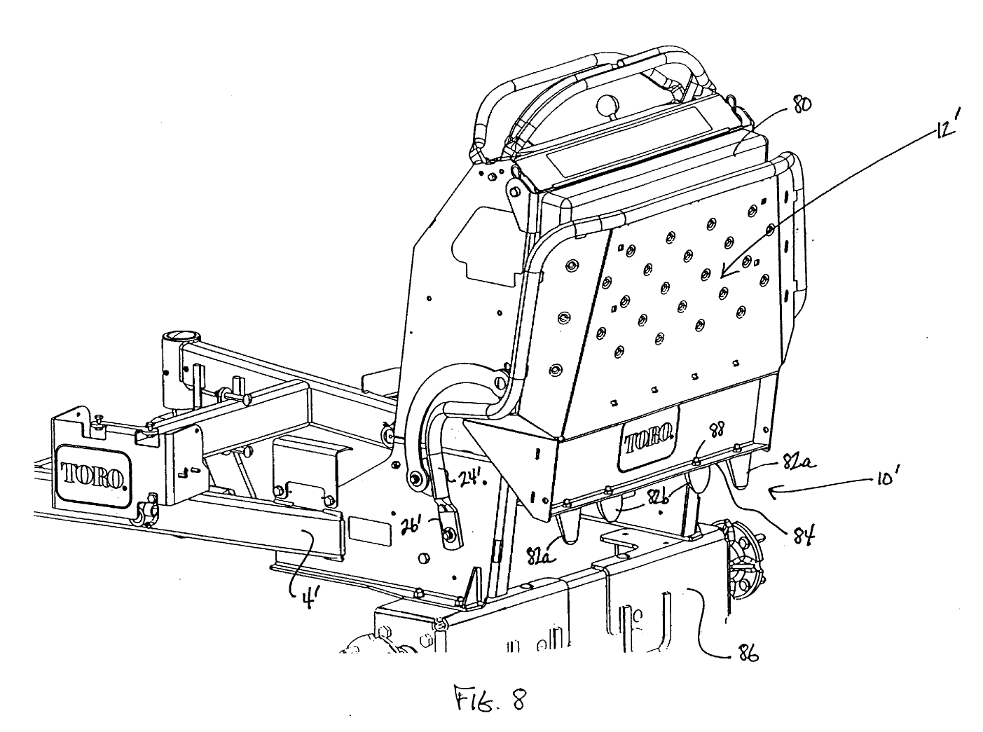

Motion about pivot axis x2′ over a large range permits platform 12′ to fold up between the substantially horizontal, deployed position shown in FIG. 7 and the substantially vertical, stowed position shown in FIG. 8. Cushioned suspension 10′ also resiliently supports platform 12′ for up and down motion around pivot axis x2′ over a smaller range during operation of the mower. Platform 12′ may be pivotally linked to a pivotal thigh pad 80 such that deploying platform 12′ into its substantially horizontal, deployed position as shown in FIG. 7 also pivots thigh pad 80 out into a deployed rearwardly and downwardly angled orientation as shown in FIG. 7. When platform 12′ is pivoted up into its stowed position as shown in FIG. 8, thigh pad 80 is pivoted inwardly towards traction frame 4′ to be closely sandwiched between traction frame 4′ and platform 12′. However, thigh pad 80 and its pivotal interconnection to platform 12′ is not part of this invention.

Cushioned suspension 10′ comprises a pair of elastomeric cushioning members 82a, 82b, i.e. rubber bumpers, located on each side of a forwardly facing edge 84 of platform 12′. Thus, there are a total of four such cushioning members 82. A first cushioning member 82a and an adjacent second cushioning member 82b are located in a first pair on the left side of platform 12′. Identical first and second cushioning members 82a and 82b are located in a second pair on the right side of platform 12′.

First cushioning member 82a in each pair has a conical shape with a rounded tip or nose. Second cushioning member 82b in each pair has a more rounded exterior surface than that of first cushioning member 82a and is in the form of a partial ovate, i.e. approximately half or slightly more than half of a complete egg shape. The most significant difference between the first and second cushioning members is the length thereof, with first cushioning member 82a being approximately 20% to 40% longer than second cushioning member 82b. When platform 12′ is in the substantially horizontal, deployed position thereof, the longer first cushioning members 82a will each engage or abut against a rearwardly facing surface of portion 86 of traction frame 4′. When no operator is standing on platform 12, the engagement of first cushioning members 82a with traction frame 4 tends to give platform 12 a slight upward bias as best shown in FIG. 7.

When an operator steps onto platform 12, the weight of the operator will tend to pivot platform 12′ downwardly about the platform pivot axis x2′, thus compressing first cushioning members 82a against traction frame 4. If the operator weighs less than a predetermined amount, e.g. 80 to 120 lbs. or so, only first cushioning members 82a will come into play and be compressed with the shorter set of second cushioning members 82b providing overload support on bumps. However, for heavier operators, namely those operators weighing more than 80 to 120 lbs. or so, first cushioning members 82a will be compressed to the point where the noses or tips of second cushioning members 82b engage against the rearwardly facing portion 86 of traction frame 4. Thereafter, both the first and second cushioning members 82a and 82b are compressed together. A heavier operator in the 160-250 pound range will significantly compress all four rubber members 82a and 82b. In either case, i.e. whether only first cushioning member 82a is being compressed or both the first and second cushioning members 82a and 82b are being compressed together, the compression continues until the weight of the operator on platform 12′ is counterbalanced by the rearward biasing force provided by the collective compression of cushioning members 52.

In this counterbalanced, cushioned configuration of platform 12′, the operator is protected from impact shocks and the like that might be encountered by traction frame 4′, i.e. such as when one or more of the wheels of the frame hit an obstruction or temporarily drop into a hole or depression in the ground. The resilient support provided by cushioning members 82 permits platform 12′ to bob up and down slightly during such an impact shock and attenuates the force of the impact shock lessening how much of the impact shock is transmitted through to platform 12′. In addition, cushioned suspension 10′ formed by cushioning members 82 attenuates the transmission of vibration from other components, such as the prime mover or the rotation of the blades in the cutting deck, to platform 12′. Thus, the ride of the operator on platform 12′ is smoother and considerably more comfortable than if cushioned suspension 10 were absent.

The use of two differently sized, elastomeric cushioning members 82a and 82b in each pair is desirable since it allows a ride that is more comfortable to both lighter and heavier operators than if a single cushioning member 82 were used. With a single cushioning member, such a cushioning member would have to be relatively stiff in order to have enough compression to absorb and counterbalance the weight of very heavy operators, e.g. more than 225 lbs. or so. Such a stiff cushioning member would not compress much at all if a light operator were to step onto platform 12′. This means that most light operators would still experience a relatively stiff ride.

However, with the two cushioning members 82a and 82b disclosed herein, first cushioning member 82a is preferably soft enough to compress readily under the weight of a light operator giving a light operator a soft and comfortable ride. But, when a heavier operator steps onto platform 12′, second cushioning member 82b also becomes effective such that both cushioning members have to thereafter be compressed. The relative hardness and softness of the two cushioning members can be adjusted to provide even heavy operators with a soft and comfortable ride. Accordingly, cushioned suspension 10′ disclosed herein provides a soft and comfortable ride for a great majority of operators regardless of the weight of such operators.

The size, shape, and durometer of the rubber bumpers 82a and 82b are selected to deliver a progressive (non-linear) load rate which is self compensating for varying operator weights. Each bumper 82a and 82b is individually attachable to platform 12′, and therefore replaceable on platform 12′, by threaded studs 88 projecting from bumpers 82a and 82b which studs 88 may be bolted to platform 12′. One benefit of this is the opportunity to install a set of 4 of the longer rubber bumpers 82a to deliver a firmer suspension for a light operator and a softer suspension for a 120-160 pound operator. An additional benefit is the opportunity to install a set of 4 of the short rubber bumpers 82b if desired to deliver a firmer suspension to support a very heavy operator exceeding 250 pounds. While the combination together of some longer bumpers 82a and some shorter bumpers 82b delivered the best over-all combination of characteristics to accommodate the widest range of potential operator weights, the Applicants found that the capability to be able to mix-and-match from two sizes and shapes of bumpers 82 was a better option than to merge the design into a single size and shape with no potential opportunity for adjusting to meet various operator sizes and various operator preferences for the feel of the suspension ride.

Various other modifications of this invention will be apparent to those skilled in the art. Accordingly, this invention is to be limited only by the appended claims.

We claim:

1. An improved mower of the type having a traction frame which is self propelled by at least one drive wheel, a cutting deck for mowing grass carried on the traction frame, and an operator platform which has at least a substantially horizontal deployed position in which an operator is able to stand atop the platform to operate the mower, wherein the improvement relates to a suspension for the operator platform, which comprises:
(a) a suspension interposed between the operator platform and the traction frame, wherein the suspension comprises:
(i) a first elastomeric bumper carried on a forwardly facing surface of the operator platform with the first elastomeric bumper resting against a rearwardly facing surface on the traction frame when the operator platform is in the substantially horizontal deployed position, and wherein the operator platform is pivotal about a substantially horizontal pivot axis when the operator platform is in the substantially horizontal deployed position thereof such that the weight of an operator standing atop the operator platform compresses the first elastomeric bumper to provide a cushioned ride to the operator standing atop the operator platform; and
(ii) a second elastomeric bumper carried on the forwardly facing surface of the operator platform with the second elastomeric bumper being shorter than the first elastomeric bumper to be spaced away from the rearwardly facing surface of the traction frame by an initial gap when the first elastomeric bumper abuts against the rearwardly facing surface of the traction frame, wherein the second elastomeric bumper is compressed by the operator standing atop the operator platform only after the first elastomeric bumper is first compressed enough by the operator's weight to close the initial gap between the second elastomeric bumper and the rearwardly facing surface on the traction frame.

1. The mower of claim 1, wherein the suspension further comprises a first pair of the first and second elastomeric bumpers carried adjacent one side of the operator platform and a second pair of the first and second elastomeric bumpers carried adjacent an opposite side of the operator platform.

2. The mower of claim 1, wherein the first and second elastomeric bumpers have different shapes.

3. The mower of claim 3, wherein the first elastomeric bumper has a substantially straight sided conical shape.

4. The mower of claim 4, wherein the second elastomeric bumper has a rounded shape in the form of a partial ovate.

5. A suspension for attaching an operator support platform to the rear of a self propelled traction frame and for providing a cushioned ride to an operator standing atop the operator support platform as the traction frame travels over the ground, which comprises:
(a) a pivotal connection for pivotally attaching the operator support platform for pivoting motion relative to the traction frame about a substantially horizontal pivot axis; and
(b) at least a pair of elastomeric bumpers positioned between the operator support platform and the rear of the traction frame when the operator is standing atop the operator support platform such that the weight of the operator atop the platform will pivot the platform downwardly in a direction tending to compress the pair of elastomeric bumpers, and wherein a first bumper in the pair of bumpers is longer than a second bumper in the pair of bumpers such that the first bumper is at least partially compressed before compression of the second bumper begins.

6. The suspension of claim 6, wherein the first and second elastomeric bumpers have different shapes.

7. The suspension of claim 7, further comprising a first pair of the first and second elastomeric bumpers carried adjacent one side of the operator platform and a second pair of the first and second elastomeric bumpers carried adjacent an opposite side of the operator platform.

8. The suspension of claim 8, wherein all of the bumpers are removably attached to the operator platform to allow all of the bumpers in the first and second pairs to selectively comprise either the longer first bumpers or the shorter second bumpers.
